(19) United States
(12) Patent Application Publication
(10) Pub. No.: US 2024/0329224 A1
(43) Pub. Date: Oct. 3, 2024

(54) ULTRASONIC SENSOR

(71) Applicant: Panasonic Automotive Systems Co., Ltd., Kanagawa (JP)

(72) Inventor: Tetsuro TANI, Osaka (JP)

(21) Appl. No.: 18/613,861

(22) Filed: Mar. 22, 2024

(30) Foreign Application Priority Data
Mar. 29, 2023 (JP) 2023-052636

(51) Int. Cl. G01S 7/521; G01S 15/931

(52) U.S. Cl. CPC G01S 7/521; G01S 15/931

(57) ABSTRACT

An ultrasonic sensor according to the present disclosure includes a case, a piezoelectric element, and one or more grooves. The case has a bottom surface and a recess formed. The piezoelectric element is disposed on the bottom surface. The one or more grooves are formed on the bottom surface of the recess or an inclined surface disposed from the bottom surface to a side surface of the recess.

### CROSS-REFERENCE TO RELATED APPLICATIONS

This application is based upon and claims the benefit of priority from Japanese Patent Application No. 2023-052636, filed on Mar. 29, 2023, the entire contents of which are incorporated herein by reference.

### FIELD

The present disclosure relates to an ultrasonic sensor.

### BACKGROUND

In an ultrasonic sensor including, for example, a case having a bottom and a recess formed and a piezoelectric element disposed on a bottom surface of the case corresponding to a bottom surface of the recess, there is technology of changing the shape of the recess to change rigidity of the case, thereby adjusting a target directivity.

A related technique is described in JP 2006-340258 A.

However, adjustment made by changing the shape of the recess of the case has a low degree of freedom, and the number of processing steps increases depending on the shape, which results in an increase in cost.

A non-limiting example of the present disclosure is made in view of the above and relates to provision of an ultrasonic sensor capable of reducing the number of processing steps while increasing the degree of freedom of adjustment of directivity.

### SUMMARY

An ultrasonic sensor according to an embodiment includes a case, a piezoelectric element, and one or more grooves. The case has a bottom surface and a recess formed. The piezoelectric element is disposed on the bottom surface of the case. The one or more grooves are formed on the bottom surface of the recess or an inclined surface disposed from the bottom surface to a side surface of the recess.

### BRIEF DESCRIPTION OF THE DRAWINGS

FIG. 1 is a diagram illustrating an example of a vehicle according to an embodiment;

FIG. 2 is a perspective view of an ultrasonic sensor according to the embodiment;

FIG. 3 is a top view of the ultrasonic sensor according to the embodiment;

FIG. 4 is a cross-sectional view of the ultrasonic sensor according to the embodiment;

FIG. 5 is a perspective view of the ultrasonic sensor according to the embodiment; and

FIG. 6 is a top view of the ultrasonic sensor according to a modification.

### DETAILED DESCRIPTION

Hereinafter, an ultrasonic sensor according to an embodiment of the present disclosure will be described in detail by referring to the accompanying drawings.

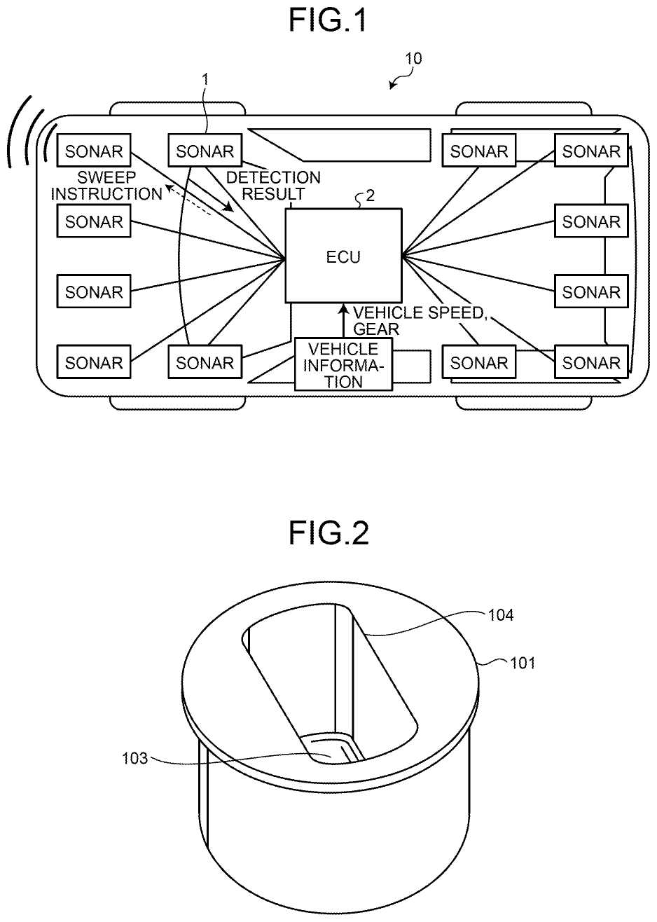

FIG. 1 is a diagram illustrating a vehicle 10 on which sonars 1, including an ultrasonic sensor 100 (described later) of the present embodiment, are mounted. A sonar 1 that detects an obstacle using an ultrasonic wave communicates with an ECU 2 and is controlled on the basis of vehicle information such as forward traveling, backward traveling, and the vehicle speed acquired from the ECU 2.

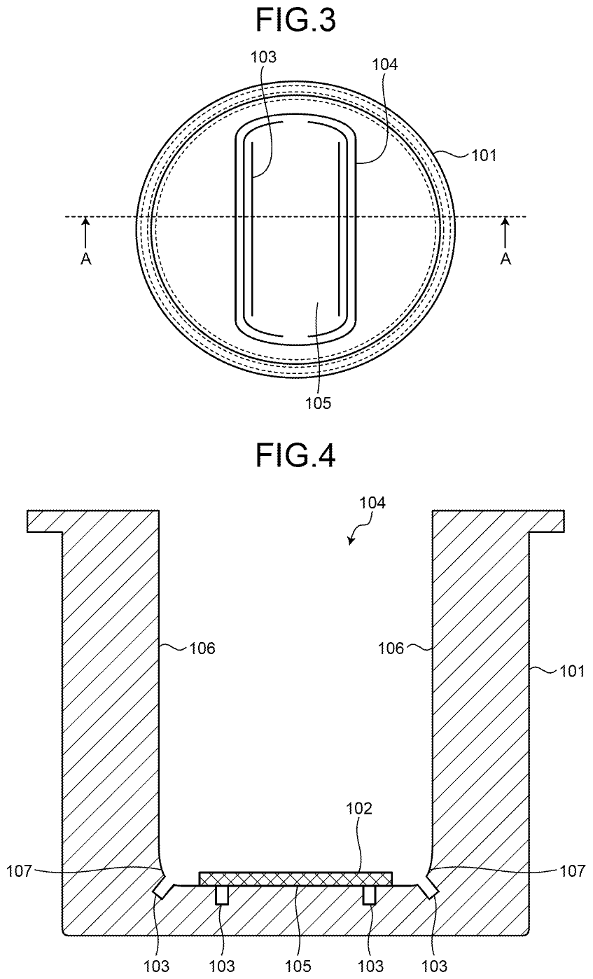

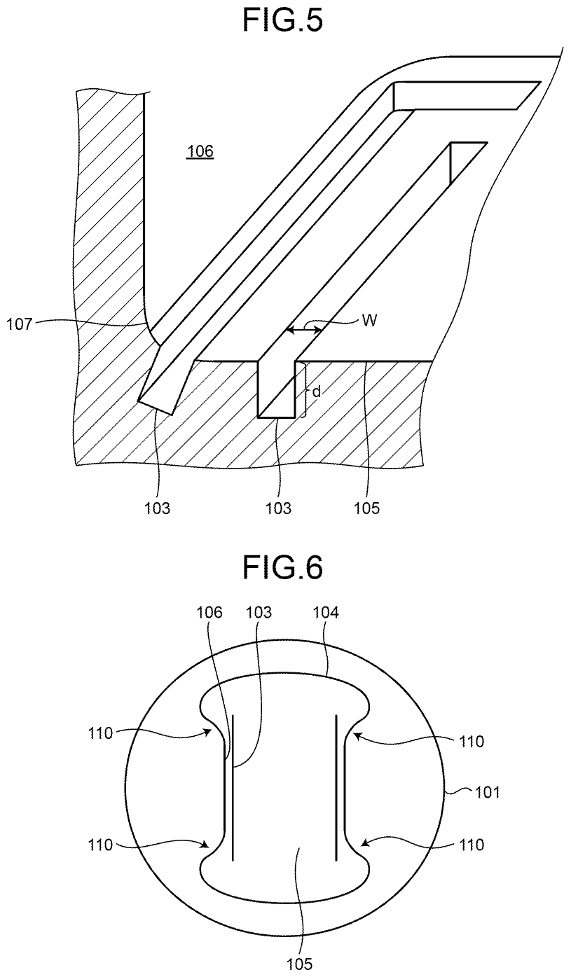

FIG. 2 is a perspective view of an ultrasonic sensor (ultrasonic transceiver) 100 of the present embodiment, and FIG. 3 is a top view of the ultrasonic sensor 100. FIG. 4 is a cross-sectional view taken along line A-A of FIG. 3, and FIG. 5 is a perspective view of FIG. 4.

Hereinafter, the structure of the ultrasonic sensor 100 will be described with reference to FIG. 4. As illustrated in FIG. 4, the ultrasonic sensor 100 includes a case 101, a piezoelectric element 102, and a plurality of grooves 103.

The case 101 is a housing having a bottom and a recess 104 formed by hollowing out. A bottom surface 105 of the recess 104 is also a bottom surface of the case 101.

The piezoelectric element 102 is disposed on the bottom surface 105 of the case 101 corresponding to the bottom surface 105 of the recess 104. The piezoelectric element 102 oscillates an ultrasonic wave by converting an applied driving voltage into a sound pressure and outputting the sound pressure.

In the present embodiment, an inclined surface 107 is disposed from the bottom surface 105 to a side surface 106 of the recess 104. The inclined surface 107 can also be used for positioning of the piezoelectric element 102 attached to the bottom surface 105. Note that it is not limited thereto, and for example, a form in which the inclined surface 107 is not disposed may be adopted.

In the present embodiment, one or more grooves 103 are formed in the bottom surface 105 or the inclined surface 107 of the recess 104. In this example, one groove 103 is formed in each of the bottom surface 105 and the inclined surface 107; however, it is not limited thereto.

For example, one or more grooves 103 may be formed on the bottom surface 105, and no groove 103 may be formed on the inclined surface 107. Alternatively, one or more grooves 103 may be formed on the inclined surface 107, and no groove 103 may be formed on the bottom surface 105. Furthermore, for example, one or more grooves 103 may be formed on the inclined surface 107, and two or more grooves 103 may be formed on the bottom surface 105. The grooves 103 may not be arranged under the piezoelectric element 102. Formation of the grooves 103 can be modified desirably depending on design conditions or others.

As illustrated in FIG. 5, in the present embodiment, a depth d of a groove 103 is greater than a width w of the groove 103. Furthermore, the width w of the groove 103 is less than or equal to 0.2 mm, and the groove 103 is formed by non-cutting processing such as laser processing. Since the grooves 103 formed on the bottom surface 105 has the sufficiently narrow width w, even if the piezoelectric element 102 is disposed on the grooves 103, there is marginal influence.

Since the rigidity of the case 101 can be partially modified by forming the grooves 103 as described above on the bottom surface 105 or the inclined surface 107, the directivity of the ultrasonic wave can also be modified. In the present embodiment, the grooves 103 are formed in a direction intersecting with the direction in which the directivity of the ultrasonic wave is enhanced by utilizing the fact that the portions of the case 101 where the grooves 103 are formed easily vibrates due to reduced rigidity.

For example, in the top view of FIG. 3, by forming the grooves 103 extending in the up-down direction of FIG. 3 in the vicinity of each of the right side and the left side of the substantially rectangular bottom surface 105 (from top view) of the recess 104, the rigidity in the vicinity of each of the right side and the left side is lowered, thereby making it easier to vibrate. As a result, the directivity in the left-right direction intersecting with the up-down direction in which the grooves 103 extend is enhanced.

In addition, since the vibration is less likely to occur at a position farther from the piezoelectric element 102 and closer to the side surface 106 in the bottom surface 105, in the case where the grooves 103 are disposed in the vicinity of the side surface 106 as in the present embodiment, the rigidity in the vicinity of the side surface 106 is reduced, thereby making it easier to vibrate, and the directivity in the direction intersecting with the extending direction of the grooves 103 can be further enhanced.

Alternatively, in contrast to the above, by forming the grooves 103 at a position away from the side surface 106, it is also possible to adjust the directivity in the direction intersecting with the extending direction of the grooves 103 so as to be weak.

Furthermore, for example, by filling the grooves 103 with a non-metallic material, vibration can be suppressed (damping effect).

In addition, the shape of the recess 104 obtained by hollowing out the case 101 can be modified depending on design conditions or others. For example, as illustrated in FIG. 6, in the top view of the case 101, the side surface 106 of the recess 104 may have a shape having portions 110 that further bite inwards. By combining directivity adjustment by changing the shape of the recess 104 and directivity adjustment by the grooves 103, more flexible directivity adjustment can be performed.

As described above, in the ultrasonic sensor 100 of the present embodiment, one or more grooves 103 are formed in the bottom surface 105 or the inclined surface 107 of the case 101 having the bottom and the recess 104 formed. As a result, the rigidity of the case 101 can be partially lowered to facilitate vibration.

In the case where the grooves 103 are formed in the bottom surface 105 or the inclined surface 107 of the case 101, the number of processing steps is smaller than that in existing technology of changing the shape of the recess 104. In addition, according to the method of the present disclosure in which the rigidity is modified by changing the number or the position of the grooves 103, the degree of freedom in changing the rigidity is also high as compared with that of the existing technology in which the shape of the recess 104 is changed to modify the rigidity, and thus the degree of freedom of adjustment of the directivity is also high.

Therefore, according to the present embodiment, it is possible to reduce the number of processing steps while increasing the degree of freedom of adjustment of the directivity of the ultrasonic sensor 100.

Moreover, as described above, the depth d of a groove 103 is larger than the width w of the groove 103, and for example, the width w of the groove 103 can be less than or equal to 0.2 mm. Since the groove 103 having such a fine width w can be formed by, for example, laser processing, the degree of freedom is also high in modifying the number or the position of the grooves 103. Therefore, the degree of freedom in changing the rigidity can be further improved as compared with the existing technology in which the shape of the recess 104 is changed to modify the rigidity.

In addition, as described above, since the width w of a groove 103 formed in the bottom surface 105 is sufficiently small (less than or equal to 0.2 mm), even if the piezoelectric element 102 is disposed on the grooves 103, there is marginal influence. Therefore, it is not necessary to consider the attaching position of the piezoelectric element 102 in an attempt to avoid the grooves 103, and the degree of freedom in installation of the piezoelectric element 102 can be increased.

In addition, as described above, it is possible to adjust the target directivity by forming the grooves 103 in the direction intersecting with the direction in which the directivity of the ultrasonic wave is enhanced using the fact that the portion of the bottom surface 105 where the grooves 103 are formed easily vibrates due to reduced rigidity.

In addition, as described above, by including the grooves 103 in the vicinity of the side surface 106 of the recess 104, the rigidity in the vicinity of the side surface 106 is reduced, thereby making it easier to vibrate, and the directivity in the direction intersecting with the grooves 103 can be further enhanced.

Furthermore, if the number of the grooves 103 is increased, the rigidity is lowered, thereby making it further easier to vibrate (conversely, if the number of the grooves is small, the decrease in the rigidity is small). Therefore, by changing the number or the position of the grooves 103 depending on the target directivity, flexible adjustment can be performed.

Note that, in the above-described embodiment, the mode in which the ultrasonic sensor 100 is applied to the sonar 1 of the vehicle 10 is illustrated as an example; however, the application of the ultrasonic sensor 100 is not limited thereto, and it goes without saying that the ultrasonic sensor can be applied to various uses.

Furthermore, the effects of the embodiments described herein are merely examples and are not limited, and other effects may be achieved.

According to the present disclosure, it is possible to reduce the number of processing steps while increasing the degree of freedom of adjustment of directivity of an ultrasonic sensor. Note that the effects described herein are not necessarily limited, and any of the effects described herein may be achieved.

While certain embodiments have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. An ultrasonic sensor comprising:
a case having a bottom surface and a recess formed;
a piezoelectric element disposed on the bottom surface of the case; and
one or more grooves formed on the bottom surface of the recess or an inclined surface disposed from the bottom surface to a side surface of the recess.

2. The ultrasonic sensor according to claim 1,
wherein a depth of the one or more grooves is greater than a width of the one or more grooves.

3. The ultrasonic sensor according to claim 1,
wherein a width of the one or more grooves is less than or equal to 0.2 mm.

4. The ultrasonic sensor according to claim 1,
wherein the one or more grooves are formed in a direction intersecting with a direction in which directivity of an ultrasonic wave is enhanced.

5. The ultrasonic sensor according to claim 1,
wherein the one or more grooves are formed in a vicinity of the side surface of the recess.

6. The ultrasonic sensor according to claim 1,
wherein the one or more grooves are formed along a shape of the bottom surface.

7. The ultrasonic sensor according to claim 1,
wherein the one or more grooves are a plurality of grooves, and
the plurality of grooves are formed in parallel to each other.

8. The ultrasonic sensor according to claim 1,
wherein the one or more grooves are a plurality of grooves, and
the plurality of grooves are formed in different directions from each other.

9. The ultrasonic sensor according to claim 1,
wherein one of the one or more grooves includes portions formed in different directions from each other.
